(19) United States
(12) Patent Application Publication
(10) Pub. No.: US 2005/0188355 A1
(43) Pub. Date: Aug. 25, 2005

(54) Executable, high-level, non-procedural modeling language and software runtime engine

(76) Inventor: Brendan McCarthy, Plano, TX (US)

Correspondence Address: FAEGRE & BENSON LLP;PATENT DOCKETING, 2200 WELLS FARGO CENTER, MINNEAPOLIS, MN, 55402, US

(21) Appl. No.: 11/048,289

(22) Filed: Jan. 31, 2005

Related U.S. Application Data
(60) Provisional application No. 60/540,936, filed on Jan. 30, 2004.

(51) Int. Cl. G06F 9/44

(52) U.S. Cl. 717/117

(57) ABSTRACT

Systems and methods for direct execution of domain models are provided. According to one embodiment, a software runtime engine directly executes an executable high-level modeling language that employs non-procedural programming constructs that can substitute for procedural constructs.

This application claims the benefit of Provisional Application No. 60/540,936, filed Jan. 30, 2004 which is hereby incorporated by reference in its entirety for all purposes.

### COPYRIGHT NOTICE

Contained herein is material that is subject to copyright protection. The copyright owner has no objection to the facsimile reproduction of the patent disclosure by any person as it appears in the Patent and Trademark Office patent files or records, but otherwise reserves all rights to the copyright whatsoever. Copyright © 2004-2005 Gorilla Logic Inc.

### BACKGROUND

1. Field

Embodiments of the present invention relate generally to software tools or software applications that are used to build other software applications. More particularly, embodiments of the present invention relate to modeling application design and direct execution of domain models.

2. Description of the Related Art

Today, software applications are constructed using paradigms, languages, and tools that are predominantly based on procedural logic. Procedural logic equates to step-wise logic, which can be very tedious since there are so many execution paths to consider for all but the most trivial applications. Hence software applications today are expensive to build in terms of time and money, often fail to fully meet user expectations, and routinely have embedded programming flaws, or ‘bugs’.

### BRIEF DESCRIPTION OF THE SEVERAL VIEWS OF THE DRAWINGS

Embodiments of the present invention are illustrated by way of example, and not by way of limitation, in the figures of the accompanying drawings and in which like reference numerals refer to similar elements and in which:

FIG. 1 is an example of a computer system in which one embodiment of the present invention may be implemented.

### SUMMARY

Systems and methods are described for direct execution of domain models. According to one embodiment, a software runtime engine directly executes an executable high-level modeling language that employs non-procedural programming constructs that can substitute for procedural constructs.

Other features of embodiments of the present invention will be apparent from the accompanying drawings and from the detailed description that follows.

### DETAILED DESCRIPTION

Apparatus and methods are described for generating fully functional and highly reliable software applications. Broadly stated, embodiments of the present invention seek to provide (1) an executable high-level modeling language that employs non-procedural programming constructs that can substitute for procedural constructs; and (2) a software runtime engine that can directly execute the high-level modeling language.

According to one embodiment, the executable high-level language is built upon and extends the Unified Modeling Language (UML) and may be referred to herein as “Gorilla UML” or “GUML.”

In the following description, for the purposes of explanation, numerous specific details regarding an existing commercial embodiment are set forth in order to provide a thorough understanding of the present invention. It will be apparent, however, to one skilled in the art that the present invention may be practiced without some of these specific details. In other instances, well-known structures and devices are shown in block diagram form.

Embodiments of the present invention include various steps, which will be described below. The steps may be performed by hardware components or may be embodied in machine-executable instructions, which may be used to cause a general-purpose or special-purpose processor programmed with the instructions to perform the steps. Alternatively, the steps may be performed by a combination of hardware and software.

Embodiments of the present invention may be provided as a computer program product which may include a machine-readable medium having stored thereon instructions which may be used to program a computer (or other electronic devices) to perform a process according to the methodologies described herein. The machine-readable medium may include, but is not limited to, floppy diskettes, optical disks, CD-ROMs, and magneto-optical disks, ROMs, RAMs, EPROMs, EEPROMs, magnetic or optical cards, flash memory, or other type of media/machine-readable medium suitable for storing electronic instructions. Moreover, embodiments of the present invention may also be downloaded as a computer program product, wherein the program may be transferred from a remote computer to a requesting computer by way of data signals embodied in a carrier wave or other propagation medium via a communication link (e.g., a modem or network connection).

While, for convenience, embodiments of the present invention are described with reference to a particular UML (i.e., GUML), constraint language (i.e., Gorilla Constraint Language), and scripting language (i.e., Gorilla Scripting Language), the present invention is equally applicable to various other implementations of high-level language constructs intended to model application design.

Terminology

Brief definitions of terms and/or phrases used throughout this application are given below.

The terms “connected” or “coupled” and related terms are used in an operational sense and are not necessarily limited to a direct connection or coupling.

The phrases “in one embodiment,” “according to one embodiment,” and the like generally mean the particular feature, structure, or characteristic following the phrase is included in at least one embodiment of the present invention, and may be included in more than one embodiment of the present invention. Importantly, such phases do not necessarily refer to the same embodiment.

If the specification states a component or feature “may”, “can”, “could”, or “might” be included or have a characteristic, that particular component or feature is not required to be included or have the characteristic.

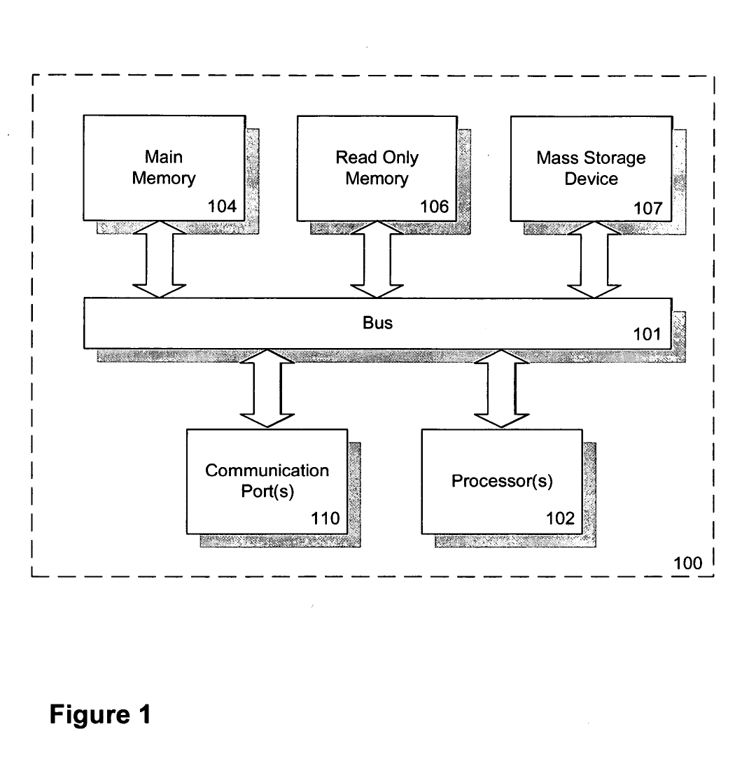

An exemplary machine in the form of a computer system 100, representing an exemplary server, in which features of the present invention may be implemented will now be described with reference to FIG. 1. In this simplified example, the computer system 100 comprises a bus or other communication means 101 for communicating information, and a processing means such as one or more processors 102 coupled with bus 101 for processing information. Computer system 100 further comprises a random access memory (RAM) or other dynamic storage device 104 (referred to as main memory), coupled to bus 101 for storing information and instructions to be executed by processor(s) 102. Main memory 104 also may be used for storing temporary variables or other intermediate information during execution of instructions by processor(s) 102. Computer system 100 also comprises a read only memory (ROM) and/or other static storage device 106 coupled to bus 101 for storing static information and instructions for processor 102. A data storage device 107 such as a magnetic disk or optical disc and its corresponding drive may also be coupled to bus 101 for storing information and instructions.

One or more communication ports 110 may also be coupled to bus 101 for allowing communication and exchange of information to/from with the computer system 100 by way of a Local Area Network (LAN), Wide Area Network (WAN), Metropolitan Area Network (MAN), the Internet, or the public switched telephone network (PSTN), for example. The communication ports 110 may include various combinations of well-known interfaces, such as one or more modems to provide dial up capability, one or more 10/100 Ethernet ports, one or more Gigabit Ethernet ports (fiber and/or copper), or other well-known interfaces, such as Asynchronous Transfer Mode (ATM) ports and other interfaces commonly used in existing LAN, WAN, MAN network environments. In any event, in this manner, the computer system 100 may be coupled to a number of other network devices, clients and/or servers via a conventional network infrastructure, such as a company's Intranet and/or the Internet, for example.

According to one embodiment, the modeling and execution methodologies described herein may be provided by an Application Service Provider (ASP) as part of an application generation tool to application developers on a subscription basis. Alternatively, embodiments of the present invention may be delivered as executable code on a computer readable medium or downloaded.

According to one embodiment of the present invention, a software tool is provided that facilitates the building of other applications. The software tool uniquely generates fully functional and highly reliable applications, and allows this to be accomplished in a considerably shorter time frame than traditional approaches and at much less expense.

According to one embodiment of the present invention, a combination of one or more of the following contribute to the efficiencies achieved:

1. Precisely defining an executable high-level language that employs non-procedural programming constructs that can substitute for procedural constructs.

2. Demonstrating in a holistic manner how these relatively few higher-level constructs can achieve the same or better result than using many more lower-level procedural constructs.

3. Implementing a software runtime engine (referred to as Gorilla eXecution Engine, or GXE) that directly executes this high-level language.

In one embodiment, the executable high-level language is built on and extends the Unified Modeling Language (UML), an industry standard language for modeling application design. Whereas part of the UML also focuses on non-procedural logic, that part is also intended as an aid or precursor to actually developing the application using another programming language—by default another procedural programming language (and therefore not directly executable).

In a commercial embodiment of this language, which may be referred to herein as Gorilla UML (GUML), one or more of the following novel features may be employed:

1. A full-featured expression language (Gorilla Constraint Language, or GCL) for performing calculations, tests, and transformations against data elements, and which is precisely defined yet accessible to modeling specialists who are not programming specialists.

2. Allowing new model constructs based on GCL expressions, including:
a. default and derived formulas for producing new information in multiple forms from existing information;
b. the ability to express constraints on allowable system state, ensuring data integrity;
c. triggers for responding to any change in system state; and
d. self-extension through new types and subtypes being definable by query rather than explicit membership.

3. A rich scripting language (Gorilla Scripting Language, or GSL) that uses GCL and provides commands to define, query, and manipulate models and data alike.

4. Model mapping for defining relationships among multiple models, allowing different views and uses of shared data elements in different contexts such as for messaging, GUIs, or simply for different user communities who prefer to view shared data from different perspectives.

5. Fine-grained access control specified directly in the model, employing rules for propagation of access control in a way that greatly minimizes the amount of access detail that must be explicitly expressed.

6. Extendable meta models, allowing for user customization of core semantics.

According to one embodiment, a software runtime component, such as the GXE, is provided that directly executes the high-level language, such as GUML. The software runtime component may incorporate one or more of the following novel features:

1. Directly executes GUML without generating code which would then have to be compiled.

2. Automatically generates GUI screens based on model definitions, but also allows these to be customizable.

3. Manages message interaction with external parties, using industry-standard XML protocols, given a GUML-based model of the message interaction.

4. Provides an end-to-end paradigm of translation of messages into GUML data counterparts, mapping of those into semantic GUML data elements, triggering off of changes to those data elements in the context of nested and long-running transactions and constraints for ensuring data integrity, and reversing this process in an outbound direction to achieve fully automated inbound/outbound message processing.

5. Automatically manages persistence.

6. Automatically manages all the features that can be expressed in GUML such as access control, model mapping, etc.

According to one embodiment, the software runtime engine employs a two-dimensional data structure (“table”) to commonly represent all data items. From this foundation, it:

1. Defines a meta model, in its own syntax, that can be used to model itself.

2. Translates model specifications produced in a variety of external modeling tools into GSL commands that can incrementally populate this model within the GXE.

3. Parses GCL into object execution graphs that operate on tables and produce tables or native data values.

4. Translates GSL into command lists the reference GCL execution graphs.

5. From the GSL in step 2, populates an instance of the meta model referred to in step 1.

6. Incorporates a translation routine that operates against this populated model and:
a. Compares a model definition and a set of table definitions, performs transformations on those table definitions so that they are consistent with the model definition. This process allows for incremental changes in the model definition to be made.
b. Decomposes complex constraints and triggers that may reference multiple model elements into simpler triggers based on GCL execution graphs that are defined in the context of a single model element.
c. Associates, to tables, linked data structures referring to these execution graphs.
d. Later on, in response to update to a row in a table, executes that table's trigger execution graphs.

7. Automatically generates GUI screens, including:
a. Dynamically reading models and generates GUI screens for browsing and editing data, or searching for data.
b. Incorporating a structured sequence of objects that be incrementally replaced allowing for full or partial customization.
c. Executing Java servlets to manage user sessions, translate input to table operations, and translation table data into formatted output.
d. Providing for ad-hoc interaction, using GSL and GCL, through an interactive shell.

8. Automatically manages message interaction, including:
a. Translating UML to/from XML.
b. Managing sending and receiving formatted messages over a network.

In the foregoing specification, the invention has been described with reference to specific embodiments thereof. It will, however, be evident that various modifications and changes may be made thereto without departing from the broader spirit and scope of the invention. The specification and drawings are, accordingly, to be regarded in an illustrative rather than a restrictive sense.

1. A system comprising:
an executable high-level modeling language that employs non-procedural programming constructs; and
a software runtime engine configured to directly execute the high-level modeling language.
